(19) United States
(12) Patent Application Publication
(10) Pub. No.: US 2004/0004910 A1
(43) Pub. Date: Jan. 8, 2004

(54) Watch assembly

(75) Inventors: R. Peter Gunshor, Yardley, PA (US); Lai Kam Hei, Sheung Wan (HK)

Correspondence Address: STEINBERG & RASKIN, P.C., 1140 AVENUE OF THE AMERICAS, 15th FLOOR, NEW YORK, NY, 10036-5803, US

(73) Assignee: PEDRE WATCH CO., INC.

(21) Appl. No.: 10/188,355

(22) Filed: Jul. 2, 2002

(51) Int. Cl. G04C 17/00; G04B 19/00; G04B 25/00

(52) U.S. Cl. 368/223

(57) ABSTRACT

A watch assembly including a body, a watch mechanism housed in the body, the mechanism including a central shaft, and a sealable insert adapted to receive and retain a liquid. The insert including a top member and a bottom member coupled to one another, the top and bottom members being structured and arranged to define a sealable cavity for receiving and retaining a liquid and/or a solid and defining a central orifice which passes through the top and bottom members for permitting the central shaft of the mechanism to pass through said insert.

### FIELD OF THE INVENTION

The present invention relates generally to watches and, in particular, to watch including a separate sealable watch insert which defines a chamber for holding a liquid and/or a solid.

### BACKGROUND OF THE INVENTION

Watches are presently available in a multitude of shapes, colors, designs and materials to suit the aesthetic desires of the user. Various attempts have been made to provide a watch that can be filled with a liquid to enhance the aesthetic appearance of the watch. However prior art attempts to provide a watch that effectively retains a liquid have had various shortcomings. The prior art watches, some of which are discussed below, were prone to leakages and/or the liquid contained within the watch interfered with the proper mechanical function of the watch. Some prior art watches were adapted to hold both liquids and solid floating components within the watch. In these watches, there was often interference between the moving parts, e.g. the hands of the watch, and the solid materials contained within watch thereby compromising the mechanical function of the watch.

U.S. Pat. No. 5,305,292 to Reynoso (hereinafter “the '292 patent”) appears to disclose a watch having a housing 13 which defines a lens cavity 25 which is filled with a liquid 16. As seen in FIG. 2 of the '292 patent, the hands of the watch are placed within and are surrounded by the liquid 16. Since the mechanical components, i.e. the hands, of the watch are in direct communication with the liquid 16 it would seem the long term effective mechanical operation of the watch would be somewhat limited. The '292 patent also discloses that solid floating components may be provided in the lens cavity. However again the hands of the watch are in direct communication with these solid floating components which would seem to compromise the accurate movement of the hands.

Another approach is illustrated in U.S. Pat. No. 4,945,523 to Lam (hereinafter “the '523 patent”). The '523 patent purports to disclose a watch having a pair of spaced apart layers (2 and 3) which are arranged above the hands of the watch. The layers 2 and 3 appear to be adapted to define a chamber 4 for holding a scented fluid or the like. The watch is structured to allow the liquid contained in chamber 8 to escape via a passage 8 in a holding ring 6 in a manner “controlled” by a semi-sealing ring (10). Thus it is an objective of the watch structure disclosed in the '523 patent to permit the liquid to escape outside the chamber to thereby permit the scent to emit from the watch.

### OBJECTS AND SUMMARY OF THE INVENTION

It is therefore an object of the present invention to avoid the above drawbacks of prior art watch assemblies.

It is yet another object of the present invention to provide a new and improved watch assembly which effectively retains a liquid and/or solid inside the watch without leakage and effectively prevents the liquid and/or solid from interfering with the mechanical operation of the watch.

It is a further object of the present invention to provide a watch assembly that includes a separate sealable watch insert, the insert being adapted to securely retain a solid and/or liquid therein.

It is still another object of the present invention to provide a new and improved watch assembly which is capable of retaining fluid and/or solid elements and is of a durable and reliable construction.

In view of the foregoing objectives a watch assembly according to a first embodiment of the invention includes a watch body a watch mechanism housed in the body, the mechanism having a central shaft and a sealable insert which defines a sealable cavity for holding a liquid and/or a solid elements. The insert includes a top wall having a central orifice, a bottom wall having a central orifice, an annular ring, and an annular core having a central orifice. The annular ring includes an upper annular seat adapted to receive the top wall and a lower annular seat adapted to receive the bottom wall. The annular core includes an upper annular recess adapted to the top wall and a lower annular recess adapted to receive the bottom wall. The central orifice of the top wall, the central orifice of the annular core and the orifice of the bottom wall are in communication to permit the central shaft of the watch mechanism to pass through the insert.

The watch assembly according to a second embodiment of the present invention includes a watch body, a watch mechanism housed in said body, the mechanism having a central shaft, and a sealable insert which defines a sealable cavity for holding a liquid and/or solid elements. The sealable insert includes a top wall having a central orifice, a bottom member, the bottom member having a bottom wall, an annular side wall and an annular central wall. The annular side wall includes an annular recess structured and arranged to receive the top wall. The bottom wall has a central orifice the central orifice being bounded by the annular central wall. The central orifice of said bottom wall is in communication with the central orifice of the top wall thereby permitting said central shaft of said watch mechanism to pass through the insert.

### BRIEF DESCRIPTION OF THE DRAWINGS

The following drawings are illustrative of embodiments of the invention and are not meant to limit the scope of the invention as encompassed by the claims.

FIG. 1 is a top plan view of a watch assembly in accordance with the invention;

FIG. 2 is an exploded cross-sectional view taken along the line of 3-3 of the watch assembly of FIG. 1;

FIG. 3 is a cross-sectional view along line 3-3 of the watch assembly of FIG. 1.

FIG. 4 is an exploded cross-sectional view of a watch assembly in accordance with a first alternate embodiment of the invention similar to the view shown in FIG. 3.

FIG. 5 is a cross-sectional view of the watch assembly according to the first alternate embodiment shown in FIG. 4;

FIG. 6 is an exploded cross-sectional view of a second alternate of the invention similar to the view shown in FIG. 3.

FIG. 7 cross-sectional view of the watch assembly according to the second alternate embodiment shown in FIG. 6.

### DETAILED DESCRIPTION OF THE INVENTION

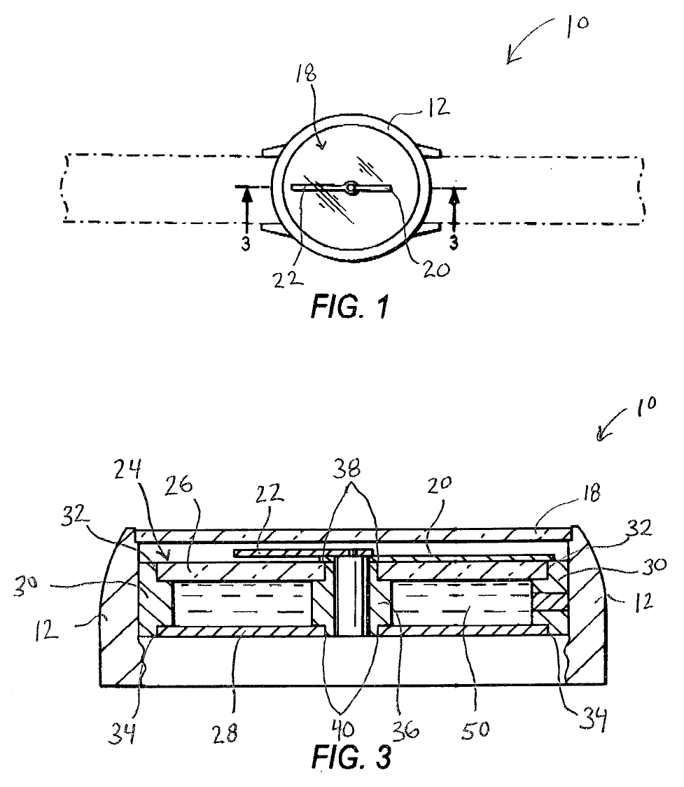

Referring now to FIG. 1, a watch assembly incorporating a presently preferred embodiment of the invention is identified generally by the reference numeral 10. The watch assembly 10 includes a watch body (case) 12, a transparent cover (crystal) 18 and watch hands 20, 22. Within the watch body 12 a conventional watch mechanism (movement) is housed.

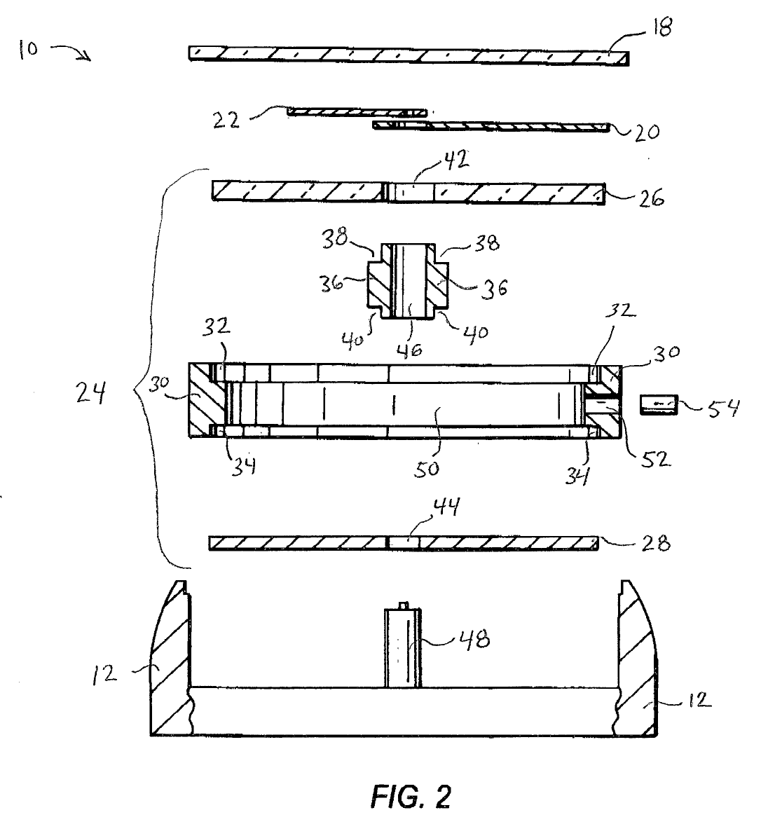

Referring now to FIGS. 2 and 3 the watch assembly according to the present invention includes a sealable insert 24. The insert 24, includes a top wall 26, a bottom wall 28 and an annular ring 30. The annular ring 30 includes an upper annular seat 32 that runs along an upper edge of the annular ring 30 and is structured and arranged to receive the top wall 26. The annular ring 30 also includes a lower annular seat 34 the rung along a bottom edge of the annular ring 30 and is structured and arranged to receive the bottom wall 28.

The insert 24 further includes an inner annular core 36. The inner annular core 36 includes an upper annular recess 38 that runs along an upper edge of the inner annular core 36 and is structured and arranged to receive the top wall 26 as shown. The inner annular core further includes a lower annular recess 40 that runs along a lower edge of the inner annular core 36 and is structured and arranged to receive the bottom wall 28 as shown.

As seen in FIG. 2, the top wall 26 and the bottom wall 28 include central orifices 42 and 44 respectively. The orifices 42 and 44 enable the top wall 26 and bottom wall 28 to be received within the upper annular recess 38 and lower annular recess 40 of the inner annular core 36. The inner annular core 36 is provided with a central orifice 46 which permits the passage of a shaft 48 of a the watch mechanism. The shaft 48 of the watch mechanism 48 is coupled to the hands 20 and 22 of the watch to thereby control the operation of the hands. As shown, the shaft 48, i.e. the canion pinion, of the watch is coupled to the hands 20 and 22 at a position above the insert 24.

In its assembled state the insert 24 defines a cavity 50 for receiving a liquid and/or solid elements. The liquid is introduced into the cavity 50 via a bore 52 provided in the annular ring 30. The liquid may be single liquid or may be a combination of liquids, such as oil and water, creating bubbles or other desirable visual effects. Other visual elements may also being introduced into the cavity for display. For example, other solid elements could be introduced into the cavity such sand, ball bearings or any other solid elements that might enhance the appearance of the watch. In addition, such solid elements could be used in conjunction with the liquid or could be used alone. Once the liquid, and any other desired visual elements, have been introduced into the cavity 50 the cavity 50 can be sealed by sealing the bore 52 with a epoxy plug 54 or equivalent sealing substance to prevent leakage. In those instances where the solid elements to be introduced into the watch are larger the bore 52 said solid elements could be introduced into the cavity 50 prior to arranging the top wall 26 into place. In this manner somewhat lager solid elements could be introduced into the cavity.

In the embodiment of the invention shown in FIGS. 2 and 3, the top wall 26 of the insert 24 is preferably constructed from a clear material such as glass or plastic. The annular ring 30 and the inner annular core 36 are preferably made from brass although other suitable materials may be used. The bottom wall 28 is preferably made from the same material as the upper wall 26 of the insert 24, e.g. glass or plastic. The upper wall 26 and/or the bottom wall 28, in the embodiment shown in FIGS. 2 and 3, may be etched or colored with numbers or other time indicating indicia. The top wall of the insert 26 and the bottom wall 28 of the insert 24 are secured to annular ring 30 and the inner annular core 36 using a suitable adhesive or sealant.

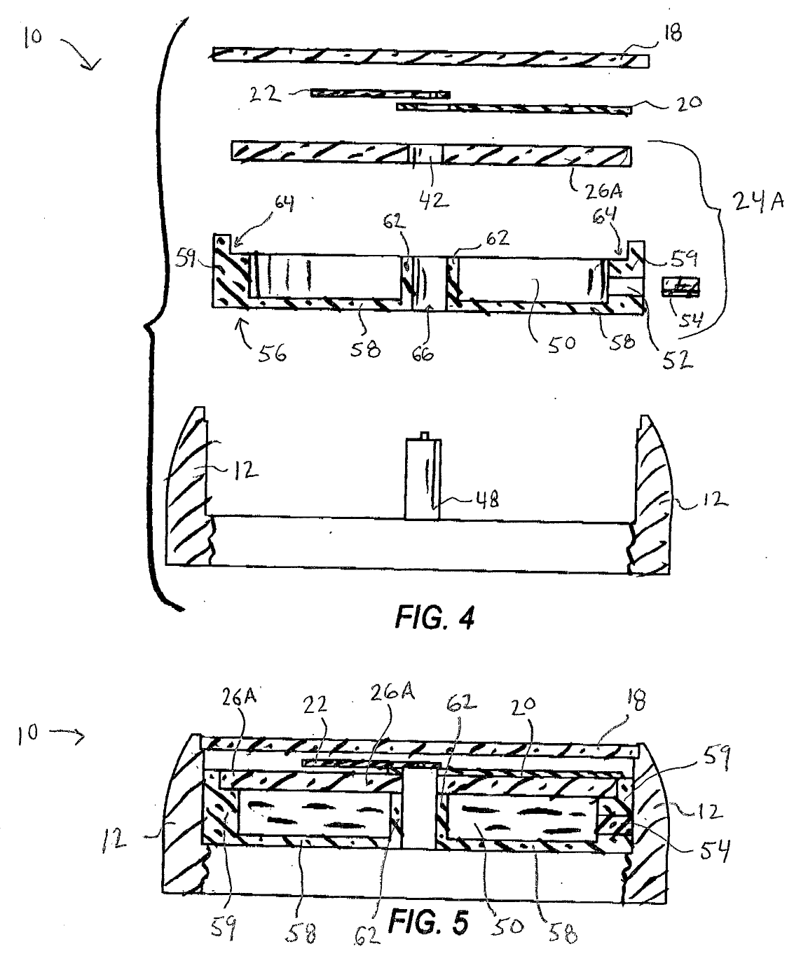

Reference is now made to FIGS. 4 and 5 which depict a first alternate embodiment of the watch assembly according to the present invention. Where applicable the same reference numbers have been used to designate the same elements as those described with reference to the embodiment shown in FIGS. 2 and 3. In the embodiment shown in FIGS. 4 and 5 the insert 24A is essentially a two piece construction including a top wall 26A and a bottom member 56. The bottom member 56 includes a bottom wall 58, an annular side wall 59 and an annular central wall 62. The annular side wall 59 includes an annular recess 64 along an upper edge of the wall, the annular recess 64 being structured and arranged to receive the top wall 26A. As shown the bottom member includes a central orifice 66 which passes through the bottom wall 58 and is bounded by the annular central wall 62. The top wall 26A includes a central orifice 42 which corresponds in position to the central orifice 66. In this manner the shaft 48 of the watch mechanism can pass through the insert 24A.

In the assembled state the insert 24A acts to define a cavity 50 for retaining a liquid and/or a liquid. After a liquid has been introduced into the cavity the bore 52 provided in the annular side wall 58 for introducing the liquid can be sealed with an epoxy plug 54 or other sealing substance. Again as discussed above it is possible that larger solid elements could be introduced into the cavity 50 directly prior to arranging the top wall 26A in place thereby enabling larger solid elements to be introduced into the cavity.

In the embodiment shown in FIGS. 4 and 5, the bottom member 56 and the top wall 26A are preferably both made of plastic. However other suitable materials could be used. For example brass could also be used. The bottom member 56 and the top wall 26A are secured together using a suitable adhesive or sealant. The top wall 26A and/or the bottom wall 58 of the bottom member 56 may be may be etched or colored with numbers or other time indicating indicia.

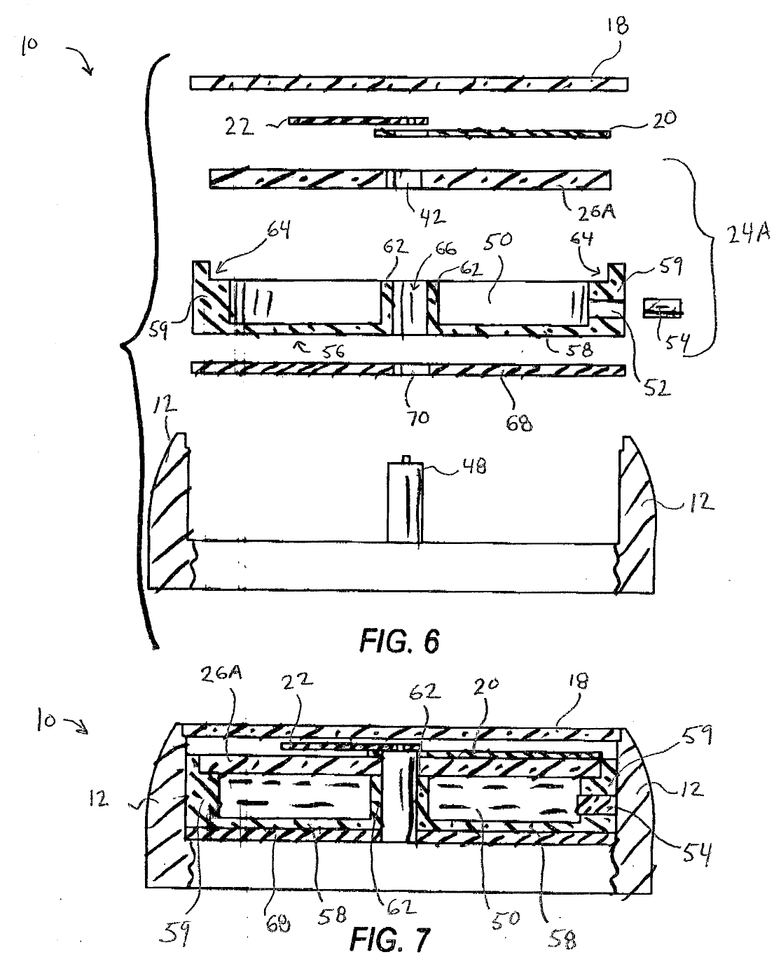

Reference is now made to FIGS. 6 and 7 which depict a second alternate embodiment of the watch assembly according to the present invention. Where applicable the same reference numbers have been used to designate the same elements as those described with reference to the embodiment shown in FIGS. 2 and 3.

The embodiment shown in FIGS. 6 and 7 is identical in all respects to the embodiment shown in FIGS. 4 and 5 except that the watch assembly is provided with an additional face plate 68 positioned below the insert 24A. In the embodiment shown in FIGS. 6 and 7 the top wall 26A and the bottom member 56 would be constructed from a clear material, e.g. plastic. The face plate 68 in this embodiment would function as the dial and be provided with numbers or other time indicating indicia. As shown the face plate 68 is provided with a central orifice 70 to permit the passage of the central shaft 48 of the watch mechanism to pass through the face plate 68 and through the insert 24A.

Although exemplary embodiments of the present invention has been shown and described, it will be apparent to those having ordinary skill in the art that a number of changes, modifications or alterations may be made, none of which depart from the spirit of the present invention. All such changes, modifications or alterations should therefore be seen as within the scope of the present invention.

I claim:

1. A watch assembly comprising:
a body;
a watch mechanism housed in said body, said mechanism having a central shaft;
a sealable insert, said insert comprising a top member and a bottom member coupled to one another, said top and bottom members being structured and arranged to define a sealable cavity and defining a central orifice which passes through said top and bottom members for permitting said central shaft of said mechanism to pass through said insert.

2. A watch assembly comprising:
a body;
a watch mechanism housed in said body, said mechanism having a central shaft;
a sealable insert which defines a sealable cavity, said insert comprising
a top wall having a central orifice,
a bottom wall having a central orifice,
an annular ring, and
an annular core having a central orifice,
wherein said annular ring includes an upper annular seat adapted to receive said top wall and a lower annular seat adapted to receive said bottom wall,
wherein said annular core includes an upper annular recess adapted to adapted to receive said top wall and a lower annular recess adapted to receive said bottom wall, and
wherein said central orifice of said top wall, said central orifice of said annular core and said orifice of said bottom wall are in communication to permit said central shaft of said watch mechanism to pass through said insert.

3. The watch assembly according to claim 2, further comprising a set of hands coupled to said central shaft of said watch mechanism, said central shaft and said set of hands being structured and arranged so that said set of hands are positioned above said sealable insert.

4. The watch assembly according to claim 2, wherein said annular ring includes a selectively sealable bore for introducing liquid into the insert.

5. The watch assembly according to claim 2, wherein said top wall and said bottom wall are constructed from a transparent material.

6. The watch assembly according to claim 2, wherein said annular ring and said annular core are made from brass.

7. A watch assembly comprising:
a body;
a watch mechanism housed in said body, said mechanism having a central shaft;
a sealable insert which defines a sealable cavity, said insert comprising,
a top wall having a central orifice,
a bottom member, said bottom member having a bottom wall, an annular side wall and an annular central wall, said annular side wall having an annular recess structured and arranged to receive said top wall,
wherein said bottom wall has a central orifice said central orifice being bounded by said annular central wall, and
wherein said central orifice of said bottom wall being in communication with said central orifice of said top wall thereby permitting said central shaft of said watch mechanism to pass through said insert.

8. The watch assembly according to claim 8, wherein said annular side wall includes a selectively sealable bore for introducing liquid into the insert.

9. The watch assembly according to claim 8, wherein said top wall and said bottom member are made of plastic.

10. The watch assembly according to claim 8, wherein said top wall and said bottom member are transparent and said watch assembly further comprises:
a face plate positioned between the bottom member and said body of said watch.

11. The watch assembly according to claim 10, wherein said face plate is provided with a central orifice permitting said central shaft of said watch mechanism to pass through said face plate.

12. The watch assembly according to claim 7, further comprising a set of hands coupled to said central shaft of said watch mechanism, said central shaft and said set of hands being structured and arranged so that said set of hands are positioned above said sealable insert.
